(19) United States
(12) Patent Application Publication
(10) Pub. No.: US 2006/0129449 A1
(43) Pub. Date: Jun. 15, 2006

(54) Hierarchical performance awards and redemption program

(76) Inventors: Larry Bayliss, Newton, IA (US); Carol Doran, Newton, IA (US); David DeRouchey, Newton, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/271,222

(22) Filed: Nov. 12, 2005

Related U.S. Application Data
(60) Provisional application No. 60/627,338, filed on Nov. 12, 2004.
(60) Provisional application No. 60/628,306, filed on Nov. 14, 2004.

(51) Int. Cl. G06F 9/44

(52) U.S. Cl. 705/11; 705/7

(57) ABSTRACT

A hierarchical method of awarding points for meeting performance objectives and providing redemption thereof is provided. The method comprises providing a general purpose computer capable of executing computer instruction code and providing a software application comprising the computer instruction code capable of carrying out the following steps; assigning indicators of performance to tasks performed by members of a hierarchical organization; assigning performance points to the indicators; awarding some or all of the points to the members based on performance of the tasks; allowing redemption of some or all of the awarded points; and displaying the points information hierarchically.

### RELATED APPLICATIONS

The present invention claims priority to, and incorporates herein by reference thereto, the following provisional applications: U.S. Patent Application No. 60/627,338 filed Nov. 12, 2004; and U.S. Patent Application No. 60/628,306 filed Nov. 14, 2004.

### BACKGROUND OF THE INVENTION

The present invention relates to a hierarchical method of awarding points for meeting performance objectives and providing for redemption thereof. In particular, the invention relates to a method of assigning indicators of performance to tasks performed by members of a hierarchical organization, and awarding points for meeting performance objectives and providing for redemption thereof.

### SUMMARY OF THE INVENTION

An object of the present invention comprises providing an improved method of awarding points for meeting performance objective and redemption thereof.

These and other objects of the present invention will become apparent to those skilled in the art upon reference to the following specification, drawings, and claims.

The present invention intends to overcome the difficulties encountered heretofore. To that end, a hierarchical method of awarding points for meeting performance objectives and providing redemption thereof is provided. The method comprises providing a general purpose computer capable of executing computer instruction code and providing a software application comprising the computer instruction code capable of carrying out the following steps; assigning indicators of performance to tasks performed by members of a hierarchical organization; assigning performance points to the indicators; awarding some or all of the points to the members based on performance of the tasks; allowing redemption of some or all of the awarded points; and displaying the points information hierarchically.

### BRIEF DESCRIPTION OF THE DRAWINGS

FIG. 1 shows a screen shot of a performance reports screen.

FIG. 2 shows a screen shot of a points reconciliation screen.

FIG. 3 shows a screen shot of a program success screen.

FIG. 4 shows a screen shot of the program success screen showing report details.

FIG. 5 shows a screen shot of an individual performance indicator report screen.

FIG. 6 shows a screen shot of a more information screen of the individual performance indicators report screen of FIG. 5.

FIG. 7 shows a screen shot of a more information screen of the individual performance indicators report screen of FIG. 6.

FIG. 8 shows a screen shot of a more information screen of the individual performance indicators report screen of FIG. 7.

FIG. 9 shows a screen shot of a more information screen of the individual performance indicators report screen of FIG. 8.

FIG. 10 shows a screen shot of a board performance indicators report screen.

FIG. 11 shows a screen shot of a more information screen of the board performance indicators report screen of FIG. 10.

FIG. 12 shows a screen shot of a more information screen of the board performance indicators report screen of FIG. 11.

FIG. 13 shows a screen shot of a more information screen of the board performance indicators report screen of FIG. 12.

FIG. 14 shows a screen shot of a more information screen of the board performance indicators report screen of FIG. 13.

FIG. 15 shows a screen shot of an account performance indicators report screen.

FIG. 16 shows a screen shot of a more information screen of the account performance indicators report screen of FIG. 15.

FIG. 17 shows a screen shot of a more information screen of the account performance indicators report screen of FIG. 16.

FIG. 18 shows a screen shot of a more information screen of the account performance indicators report screen of FIG. 17.

FIG. 19 shows a screen shot of a more information screen of the account performance indicators report screen of FIG. 18.

FIG. 20 is a screen shot of a combined data performance indicators report screen.

FIG. 21 is a screen shot of an individual performance indicators by job position report screen.

FIG. 22 is a screen shot of a board performance indicators by job position report screen.

FIG. 23 is a screen shot of an account performance indicators by job position report screen.

FIG. 24 is a screen shot of a combined performance indicators by job position report screen.

FIG. 24a is a screen shot of a more information screen of the combined performance indicators by job position report screen of FIG. 24.

FIG. 25 is a screen shot of a program success-monthly totals screen.

FIG. 26 is a screen shot of a program success-by month, by year screen.

FIG. 27 is a screen shot of a participant activity summary screen.

FIG. 28 is a screen shot of a data administration home page.

FIG. 29 is a screen shot of an add coordinator screen.

FIG. 30 is a screen shot of a second add coordinator screen.

FIG. 31 is a screen shot of a third add coordinator screen.

FIG. 32 is a screen shot of a fourth add coordinator screen.

FIG. 33 is a screen shot of an add participant screen.

FIG. 34 is a screen shot of a second add participant screen.

FIG. 35 is a screen shot of an achievement data screen.

FIG. 36 is a screen shot of a second achievement data screen.

FIG. 37 is a screen shot of a third achievement data screen.

FIG. 38 is a screen shot of a fourth achievement data screen.

FIG. 39 is a screen shot of an achievement data summary screen.

FIG. 40 is a screen shot of an account activity screen.

FIG. 41 is a screen shot of a points redemption screen.

### DETAILED DESCRIPTION OF THE INVENTION

In the Figures, is shown a hierarchically based multi-level performance award and redemption system. The system is comprised of a computer software application capable of running on a general-purpose computer. Preferably, the software-based application is designed to be run over a network of computers, and most preferably over a global computer information network such as the Internet. The system is designed to track the performance of some type of an organization. In the preferred embodiment, the organization is a business, however, those with ordinary skill in the art will appreciate that the invention is not so limited. In particular, the organization could be a charitable organization, a club or a group, an educational group, a social group, and the like.

The basic structure of the invention involves the awarding of points based on a predefined success criterion, and then those points can be redeemed for merchandise. For example, the organization may designate certain events or tasks as indicators of performance, and then award points to its members upon the accomplishments of those tasks. The performance indicators can include any measurable parameter or success or performance as defined by the organization involved, including, without limitation, performance indicators of cost, revenue, productivity, safety, and the like. The members then accumulate points that can be redeemed at a later point in time for merchandise or other items. Using the hypothetical trucking company as an example, the tasks include drivers avoiding collisions, avoiding personal injuries, on-time pickup, compliance with Department of Transportation logs, and the like. The tasks and points can be awarded to individual members, or to groups within the organization, and combinations thereof.

More particularly, the system awards points based on three different hierarchical groupings in the organization, namely, individual, department, and facility. In the preferred embodiment, throughout the application, of a hypothetical trucking company the department is referred to as a board, and the facility is referred to as an account. The individuals are the lowest level of the organization and using the hypothetical trucking company example they would comprise employees/truck drivers. The individuals are typically organized into larger groups under a common manager; normally, there would be many such groups in the organization. This level of the organization is known as the board level. The next level is the account level and it consists of all the boards, or the entire organization. Points are awarded at all three levels. One achievement by an individual can result in the award of points at the board, and account level as well the individual level. In this manner, the points merge from lower levels to higher levels. Also, points can be awarded at the board and account level, which do not come from the individual level.

In a similar manner, the system also awards points based on time periods. Points are awarded monthly, quarterly, and annually across all three hierarchical levels (individual, board, and account). The time period points also merge. For example, one achievement accumulates in quarterly, and annual points. Also, points can be awarded at the quarterly and annual levels, which do not come from the monthly level. In this manner, the points accumulate not only from the bottom to the top of the organization, but over time as well.

Those of ordinary skill in the art will understand that the invention in not necessarily limited to three hierarchical levels and three time period levels, that more or less levels can be used without departing from the scope of the intended invention.

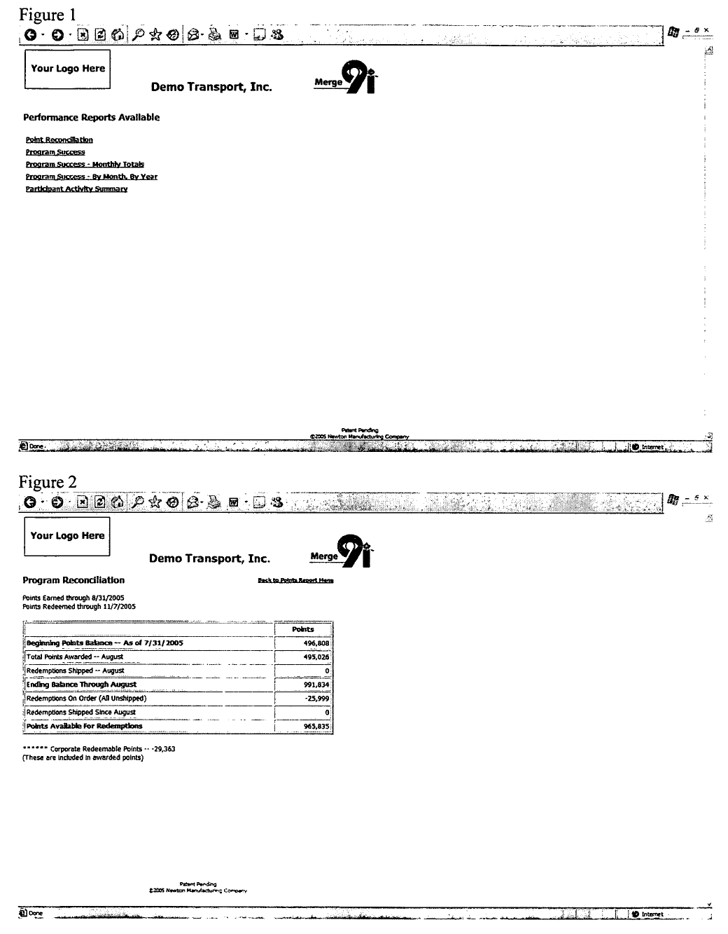

FIG. 1 shows an embodiment of the invention for a hypothetical transportation company. FIG. 1 shows the home or startup screen of the application and includes a plurality of programming options, each of which will be disclosed in greater detail hereinbelow.

Selecting the points reconciliation option shown in FIG. 1 displays the screen shown in FIG. 2. This screen shows an overall reconciliation of the points earned and redeemed for the dates shown. The program reconciliation screen shown in FIG. 2 displays the current status of all points awarded and redeemed for the fictitious entity.

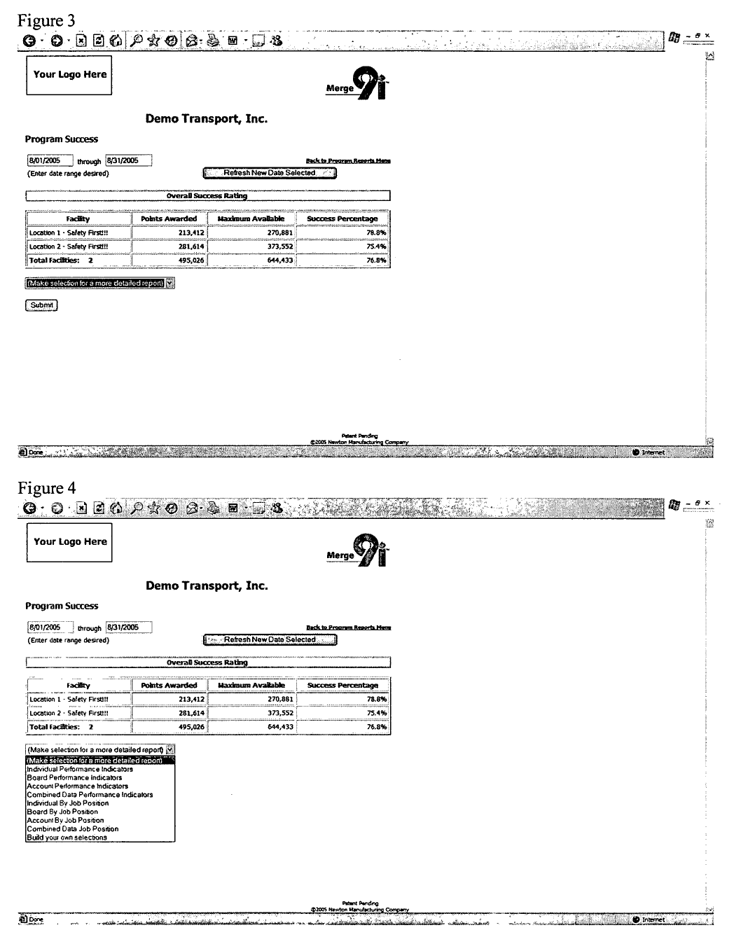

Selecting the program success option shown in FIG. 1 displays the program success screen shown in FIG. 3. This screen displays the overall structure of the hypothetical entity, which in this case consists of two locations. Also displayed is the points awarded by location, the maximum points available by location, and the percentage of the maximum points available that have been awarded. Additionally the screen allows for entering date ranges to display overall success ratings for different periods of time. The program success screen of FIG. 3 has a drop down window that allows the user to make a plurality of selections to view more detailed reports relating to the hypothetical entities performance. The details of these screens is described hereinbelow.

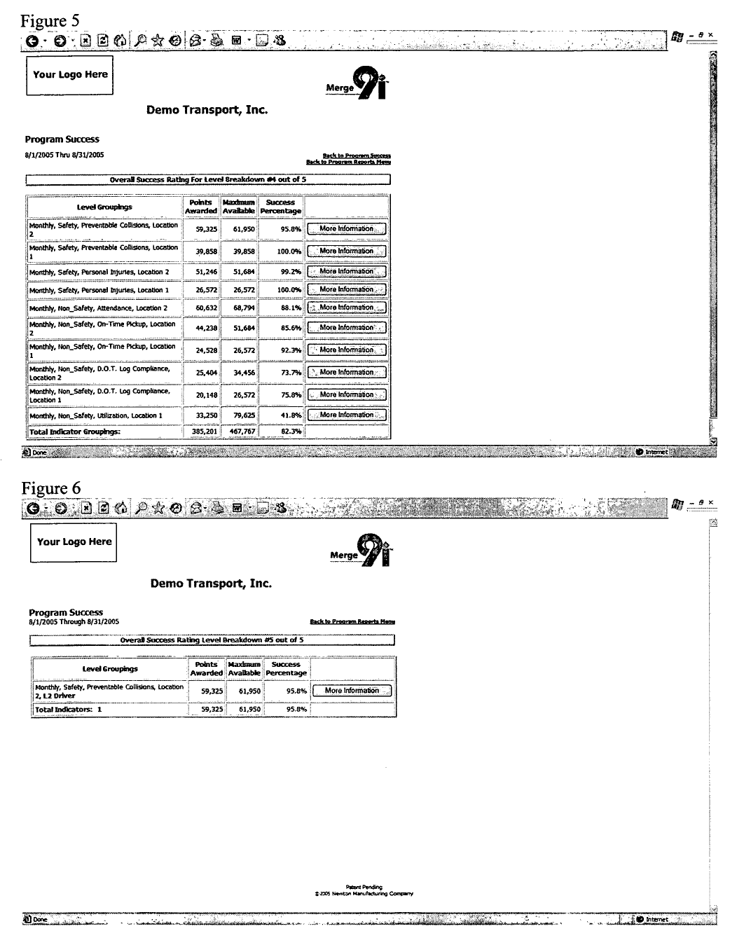

Selecting the individual performance indicators report shown in FIG. 4 displays the screen shown in FIG. 5. In this screen a series of level groupings is displayed which each consist of a particular indicators by which individuals within the subject organization are evaluated. In particular successful performance of the indicators results in the awarding of points. FIG. 5 shows that for the hypothetical organization there are ten individual indicators each with a certain number of points awarded from a maximum available points generating a success percentage for each indicator. It is important to note, that the level groupings for the indicators have a hierarchical organization. In particular, FIG. 5 shows that each indicator is a monthly indicator, is either a safety or a non-safety indicator, has a title-such as preventable collisions, and is associated with a location of the hypothetical entity. Those of ordinary skill in the art will appreciate that the type of performance indicators can and will vary from those disclosed in reference to the preferred embodiment. The exact hierarchical arrangement can and will vary depending on the organization. Preferably, the hierarchical organization will be dictated by the hierarchical configuration of the organization participating in the awards and redemption program. In each row of the table in FIG. 5 there appears a more information button. Selecting the more information button will display additional information about the level-grouping indicator associated with that row. In particular the information will be a more particular breakdown of the points information shown in the row of the table.

Selecting the more information button for the first row of the table shown in FIG. 5 will display the screen shown in FIG. 6. This screen displays the monthly safety information for the indicator preventable collisions for location 2 of the entity and for the group of employees holding the position of driver at this location for the entity. This screen could display additional information if the indicator preventable collisions included a larger hierarchical grouping within the organization. In this case, the indicator is represented by one such group. Again, a more information button is available to show further details about the points associated with the indicator group shown in FIG. 6.

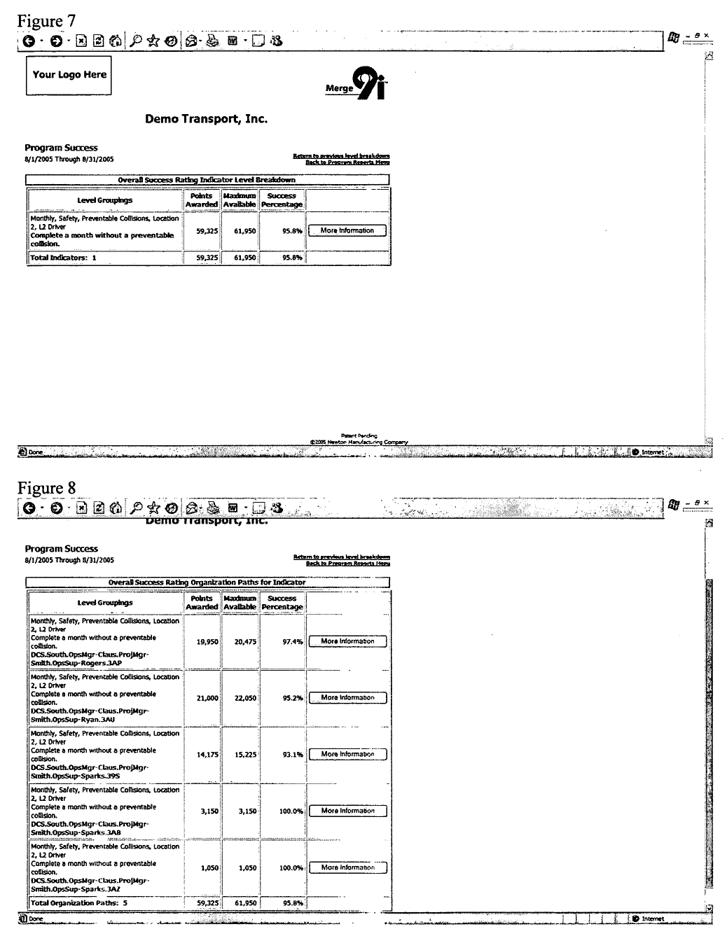

Selecting the more information button in FIG. 6 displays the screen shown in FIG. 7. In this case, because the grouping shown in FIG. 6 consists of one group, the screen shown in FIG. 7 is essentially the same as that shown in FIG. 6. If the level-grouping indicator shown in FIG. 6 included a larger hierarchical grouping, selecting the more information button would display multiple rows for each group within the hierarchy.

Selecting the more information button shown in FIG. 7 displays the screen shown in FIG. 8. In FIG. 8 the information shown in FIG. 7 is further broken down by a hierarchical sub-grouping of the performance indicator preventable collisions for location number 2 for the employee group drivers. In particular, each row displays the points awarded from a maximum available points and a success percentage for a group of drivers under a specific supervisor, who is under a specific project manager, who is under a specific operations manager. Again, this hierarchical structure can and will vary depending on the organization involved. In any event, the information shown in FIG. 8 allows for determining the various success percentages of each of the departments shown in FIG. 8, which when combined represent the information shown in FIG. 7. Additionally, a more information button is available to further examine the information displayed in each row of the table in FIG. 8.

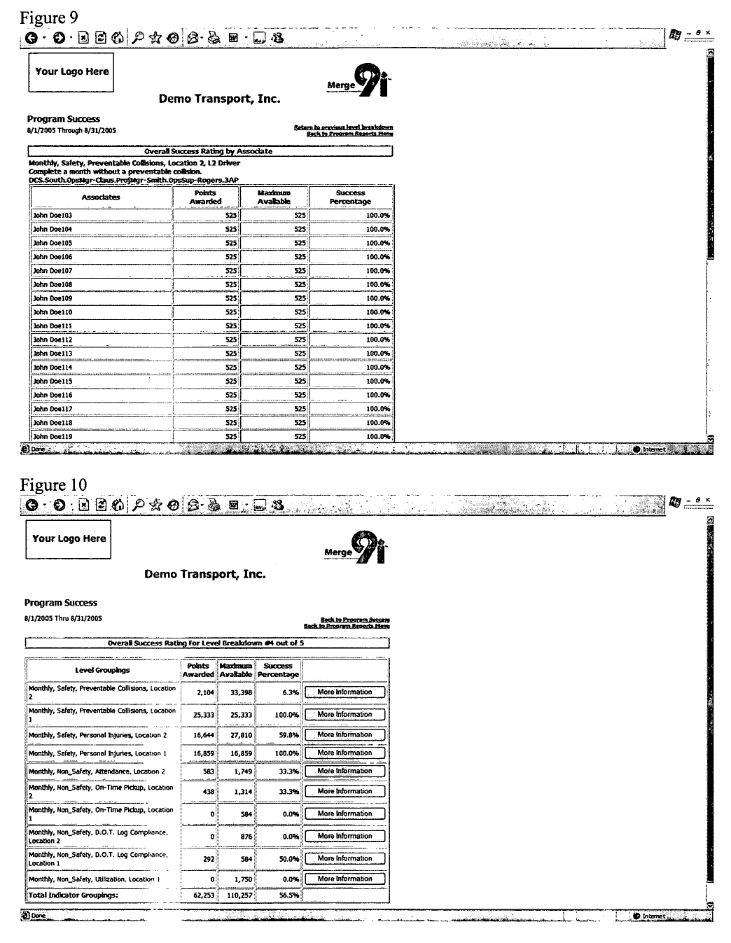

Pressing the more information button for the first row of information displayed in FIG. 8 displays the screen shown in FIG. 9. FIG. 9 displays the points awarded from a maximum available points and success percentages for each individual driver within the hierarchical grouping shown in the first row of FIG. 8. The information shown in FIG. 9 is the lowest level of information, and therefore does not include a more information button. Accordingly, the screens shown from FIG. 4 through FIG. 9 show the general format of the system of the present invention where in generalized high level hierarchal data group is displayed, giving the user the ability to select additional information about a sub-set of the hierarchical grouping, until the user steps from the top of the hierarchical grouping to the bottom of the hierarchical grouping. This system of display of information is repeated through the present invention.

The individual performance indicators are indicators that are assigned to individuals who generally occupy the lowest level of the hierarchal structure of the organization. Points are then awarded based on the individual's performance from a maximum allowable point total, which allows for calculating a success rating. The numbers awarded for the individuals are then tallied for each of the higher-level hierarchical groups in order to construct a success rating for each level of the hierarchy. Points are also available to be awarded for other performers in the organization. In particular, FIG. 4 shows a detailed report option entitled board performance indicators. The board level group represents a subset of the organization. In the preferred embodiment, the board could be a department within the hypothetical trucking company. In this grouping, indicator points can be awarded to management personnel based on the achievements of the personal they manage, also the individual participants continue to earn points for their individual achievements separate from the board level points. In some cases, management personal can earn points based on their individual performance as well. Selecting the board performance indicators option in FIG. 4 displays the program success screen shown in FIG. 10. This screen shows each of the indicators that make up board performance. Again, the level groupings show the indicators are hierarchically organized and have an associated points awarded from a maximum allowable points and success rating associated with each row in the table.

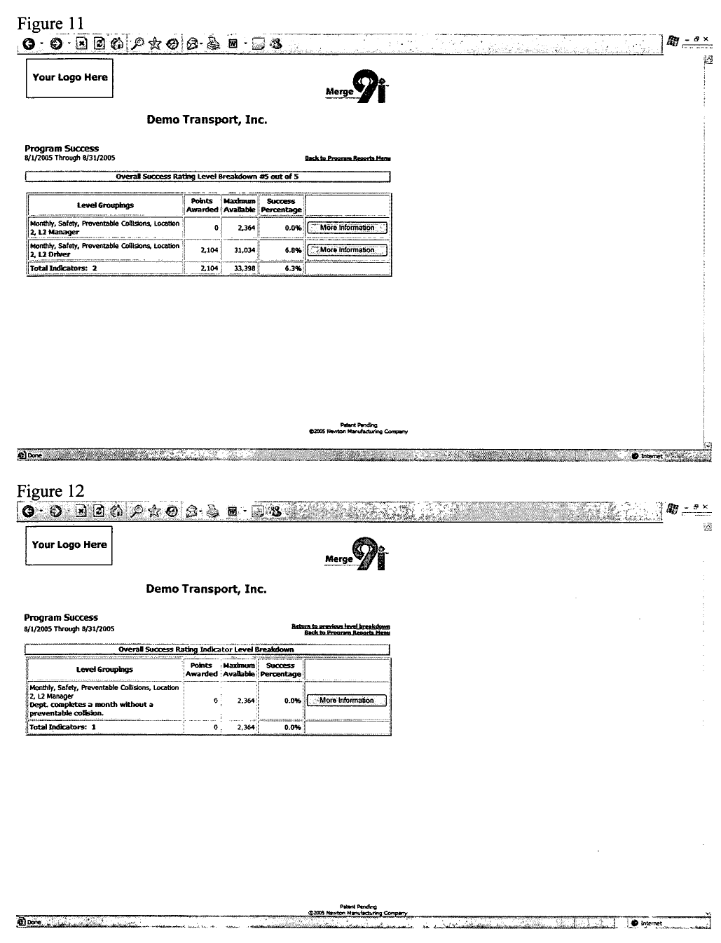

Selecting the more information button for the first row shown in FIG. 10 displays the screen shown in FIG. 11. In particular, FIG. 11 shows that the monthly safety preventable collisions indicator for location 2 is comprised of two groupings. The first grouping is for the managers, and the second grouping is for a class of employees (drivers) managed by these particular managers.

Selecting the more information button from the first row of the table shown in FIG. 11 displays the screen shown in FIG. 12. FIG. 12 displays only one row of information, however, this would not necessarily be the case if the information displayed in the first row of the screen shown in FIG. 11 was comprised of more than one grouping.

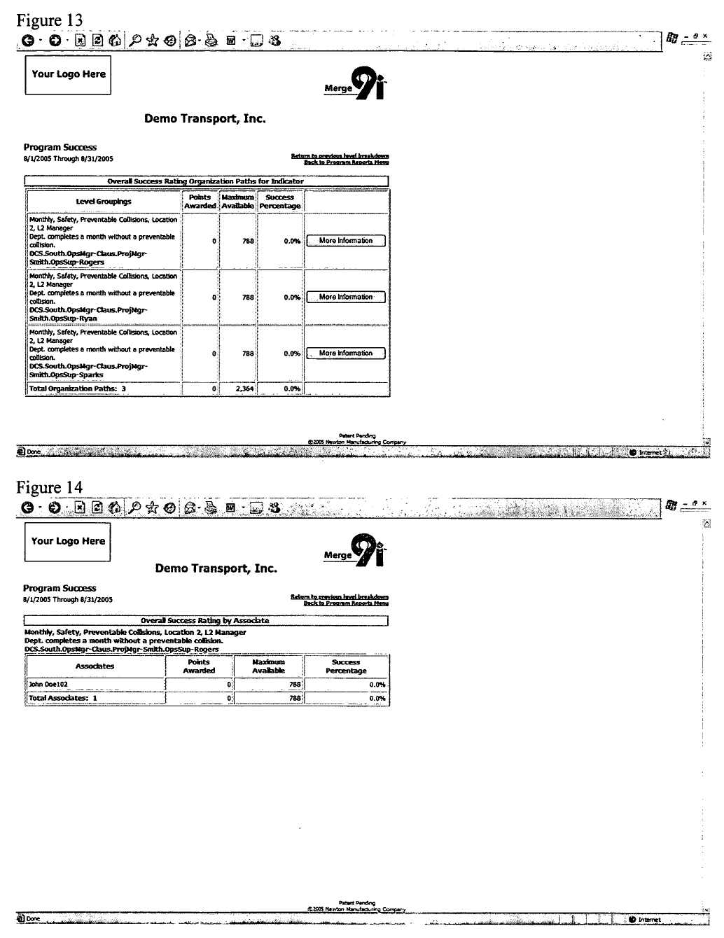

Selecting the more information button shown in FIG. 12 shows the screen shown in FIG. 13. This screen shows that the information shown in FIG. 12 is comprised of a sub-set of three managerial groupings. In particular, these include three operations supervisors all under the same project manager and the same operations manager.

Selecting the more information button for the first row of the information displayed in FIG. 13 displays the screen shown in FIG. 14. FIG. 14 shows that the first row of information displayed in FIG. 13 is further comprised of information about one particular employee, who in this case is a manager.

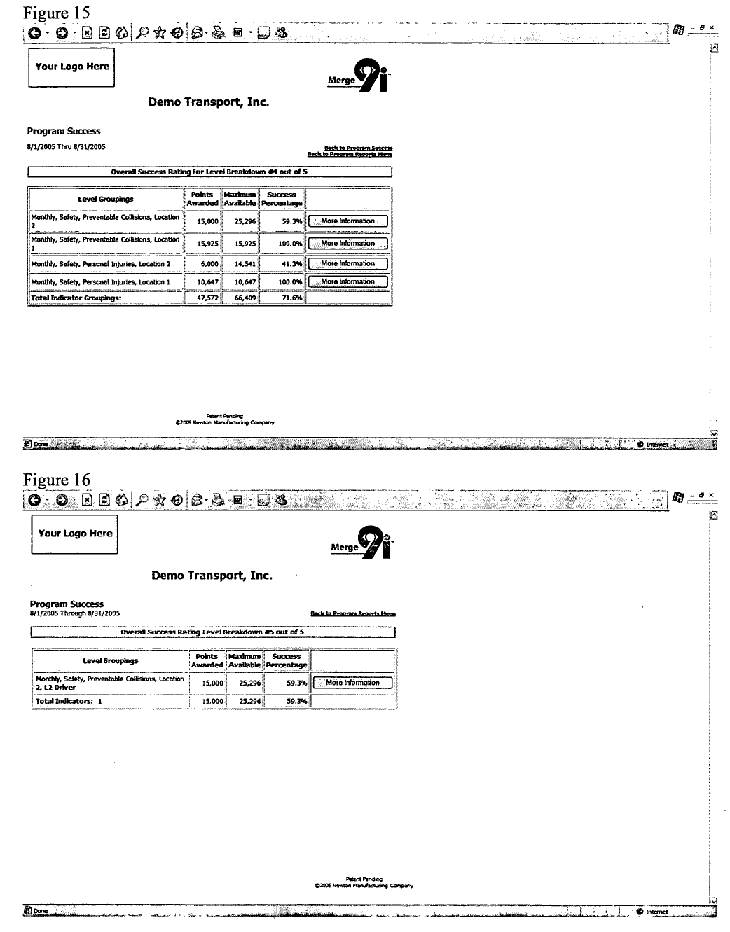

Returning to FIG. 4, selecting the account performance indicators displays the screen shown in FIG. 15. As in the case with individual indicators, and board/department level indicators, additional indicators are assigned based on the performance of the account /facility within the entire fictitious organization. The account performance indicators report displays this information. Thus in the embodiment for the fictitious transportation corporation the total performance is a combination of the individual, board, and account performance indicators. FIG. 15 shows a separate rule for each of the account performance indicators, and includes a more information button for each row.

Selecting the more information button for the first row of the information displayed in FIG. 15 displays the screen shown in FIG. 16. This information shows the grouping (or groupings) that are the components of the groupings shown in the first row of FIG. 15.

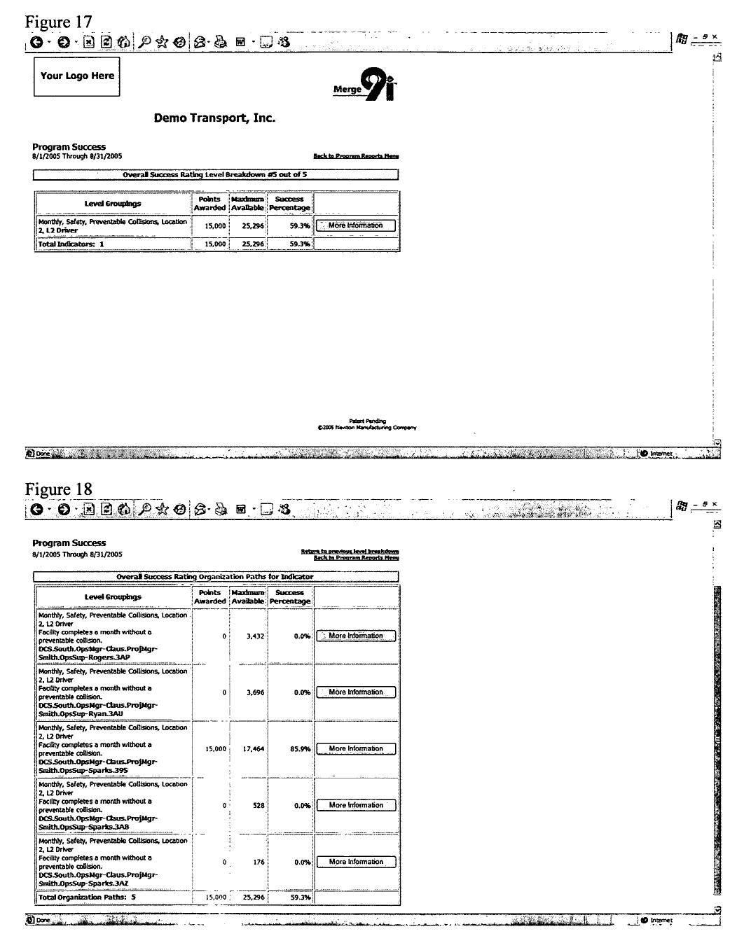

Selecting the more information button shown in FIG. 16 displays the information shown in FIG. 17. In a similar manner, selecting the more information button shown in FIG. 17 displays the screen shown in FIG. 18. FIG. 18 shows that the grouping of FIG. 17 is made up of five different hierarchical groupings, which consist of a grouping for each operations supervisor for a particular project manager and a particular operations manager.

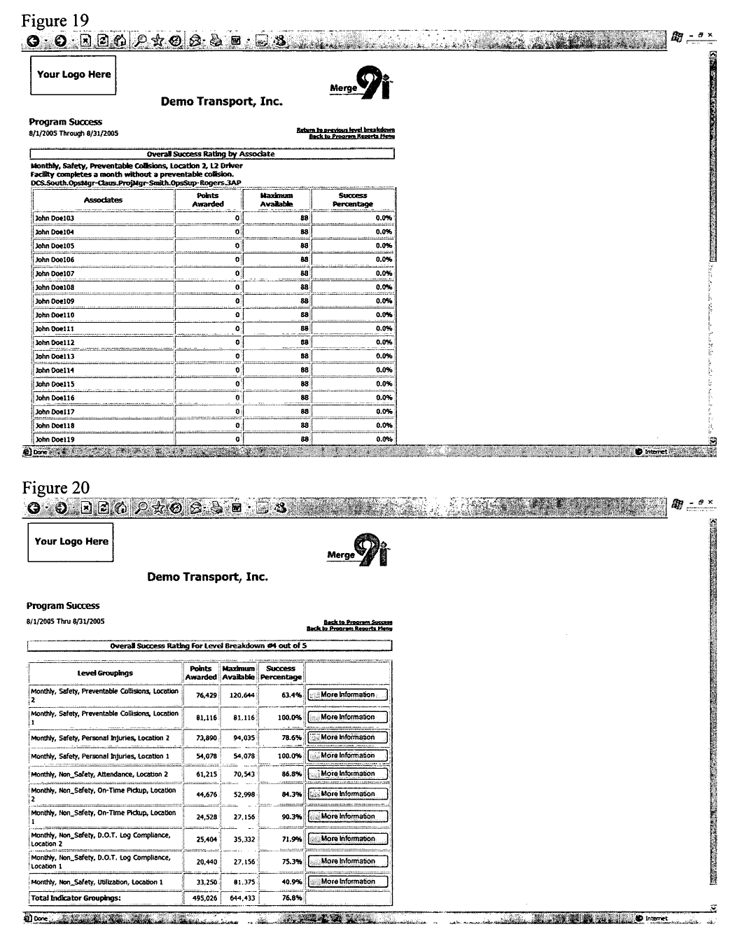

Selecting the more information button for the first row of FIG. 18 displays the information shown on FIG. 19. FIG. 19 shows each of the individual employees who make up the grouping shown on the first row of the table in FIG. 18.

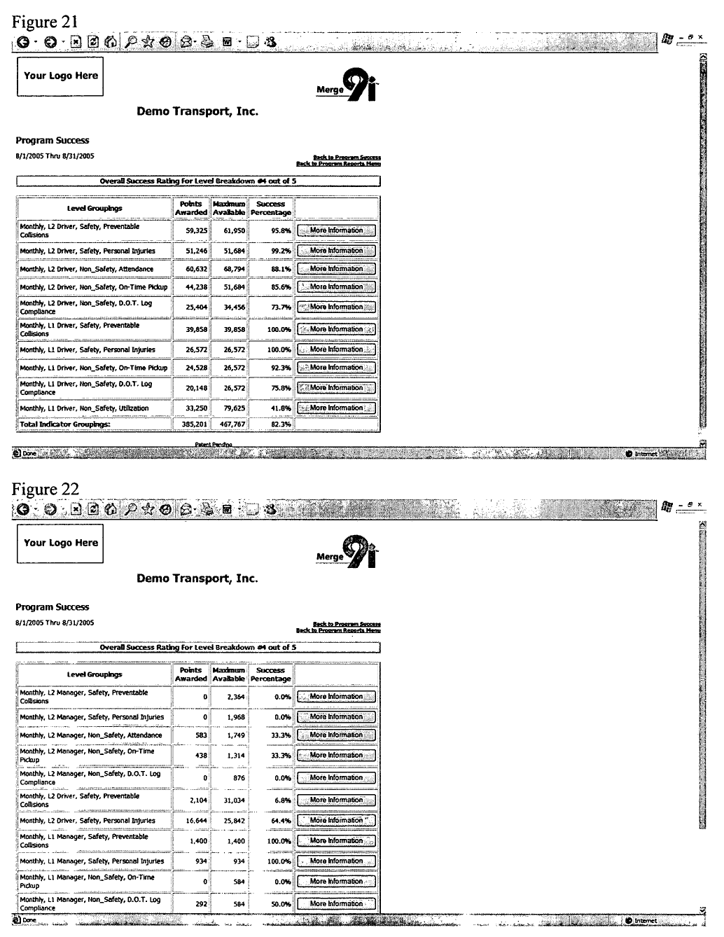

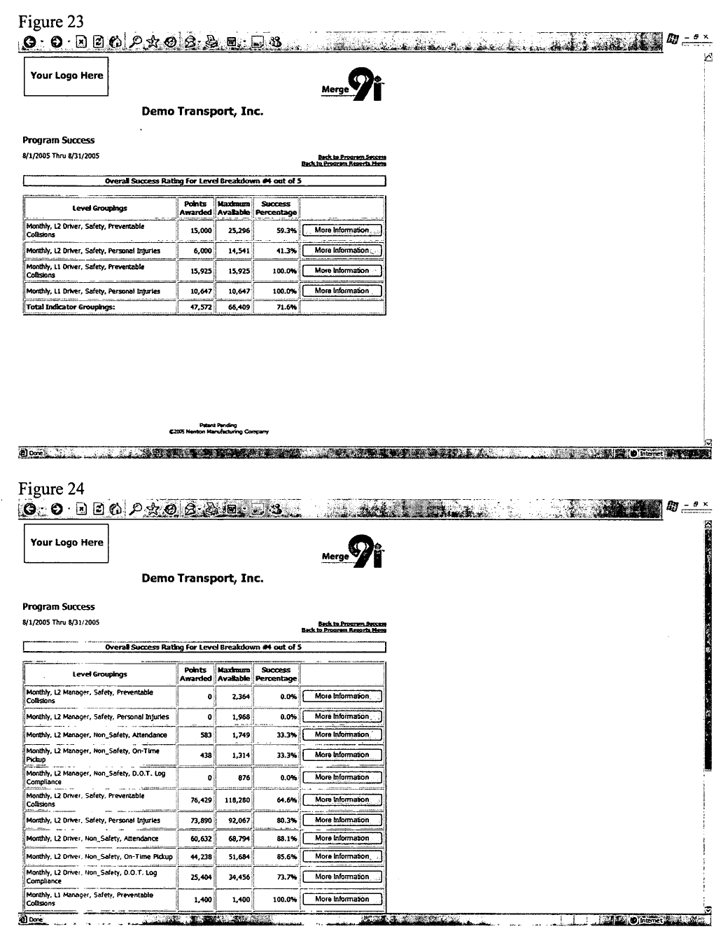

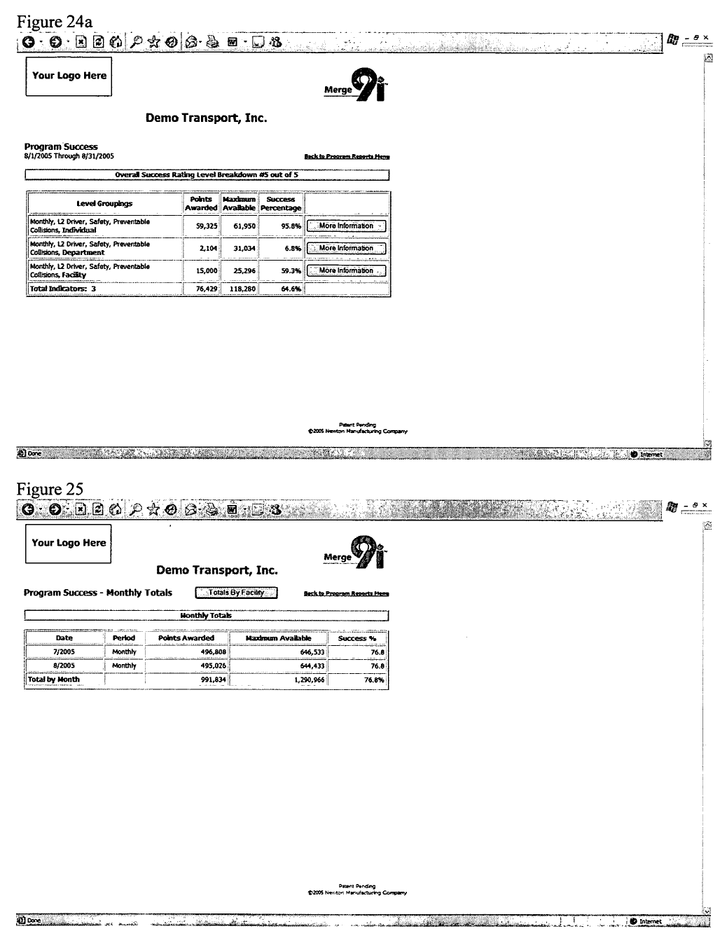

Returning to FIG. 4, selecting the combined data performance indicators report displays the screen shown in FIG. 20. As indicated the total performance rating is a combination of individual, board, and account performance indicators, and this is the information displayed in the combined data performance indicators page. The information is displayed in the same hierarchical manner as described hereinabove. In particular, the first row shows entries for monthly safety preventable collisions for location 2. A more information button is available to show detailed information about each hierarchical sub grouping in a manner identical to that disclosed in reference to the individual, board, and account performance indicators. Returning again to FIG. 4, another group of detailed reports displays the information in a slightly different hierarchical manner. In particular, detailed reports are available for individual by job position, board by job position, account by job position, and combined data job position. Each of these groupings is essentially identical to those disclosed hereinabove with the exception that they are broken out by job position at the second highest hierarchical level. In particular, FIG. 21 shows the screen that is displayed by depressing the individual by job position detailed report displayed in FIG. 4. FIG. 21 shows a separate entry for each hierarchical grouping disclosed hereinabove, with the exception of the insertion of job position in the hierarchical structure. Similar to the other screens a more information button is available to display the hierarchical grouping of each individual row in a manner that is the same as that disclosed hereinabove. FIG. 22 shows the screen that is displayed by depressing the board by job position detailed report option shown in FIG. 4, and is essentially identical in operation to the board by job position detailed report described hereinabove. Similarly, FIG. 23 displays the screen that results from pressing the account by job position detailed report option shown in FIG. 4. Finally, FIG. 24 shows the screen that results from pressing the combined data job position detailed reports option shown in FIG. 4. FIG. 24a shows the screen that results from pressing the more information button on the sixth row of the table shown in FIG. 24. The information displayed in FIG. 24a shows that the points awarded by job position include separate point totals for individual, department, and facility levels for the particular safety event. This shows how the points are awarded at each level separately, and then merge together to form the total.

Returning to FIG. 1, the home screen also includes a program success-monthly totals options, which if pressed displays the information shown in FIG. 25. In particular, the points awarded from the maximum available and the success rating is displayed by month for the entire organization. Additionally, a totals by facility button is available which if selected will show the same information except in a separate table for each facility within the organization.

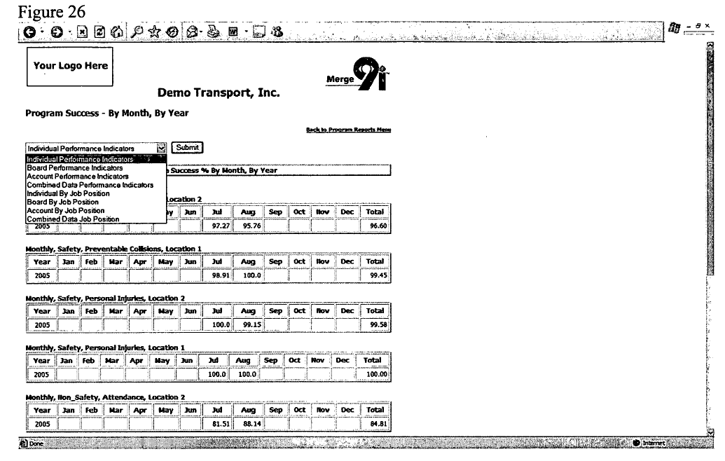

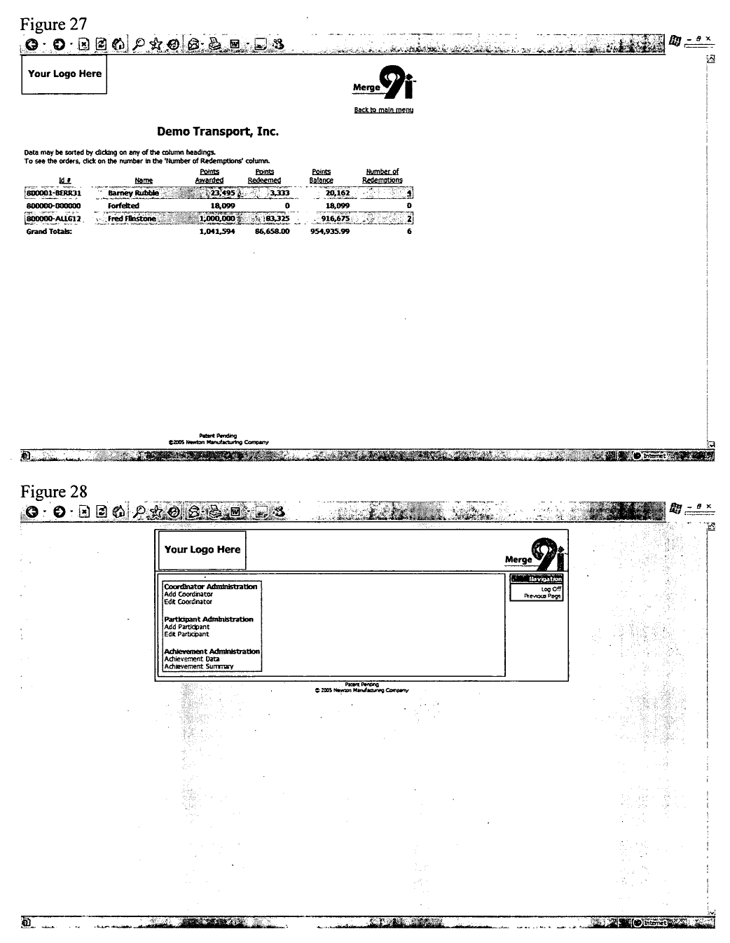

FIG. 26 displays the information shown if you select the program success-by month, by year option shown in FIG. 1. In particular FIG. 26 shows a summary of the points awarded from the maximum available and success rates by year and by month. Additionally, a drop down menu allows for selecting each of the different types of performance indicator reports shown in FIG. 4, to allow display of subsets of the information by year and by month.

FIG. 28 shows information that is displayed by showing the participant activity summary option on FIG. 1. This screen displays information by individual employee (in the case of the hypothetical transportation company), along with ID number, points awarded, points redeemed, a balance, and the number of redemptions for the employee. The columns can be sorted by clicking on the column headings.

Another aspect of the present invention comprises data administration. FIGS. 28-39 show the data administration functions of the system. FIG. 28 shows the main data administration screen, which includes a coordinator administration area for entering information about coordinators who will perform the data administration function, a participant administration area to enter information about the members of the organization, and an achievement administration area for entering information related to the performance of tasks that will result in the award of points in response thereto. Also, displayed is achievement summary information, which allows for tracking the status of award of points by coordinator.

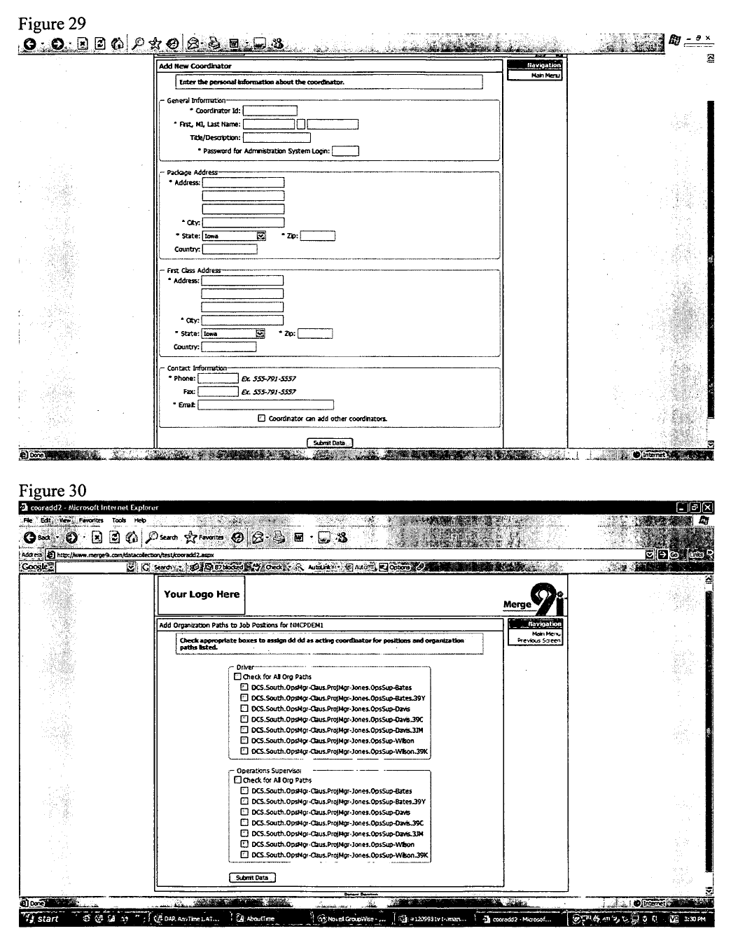

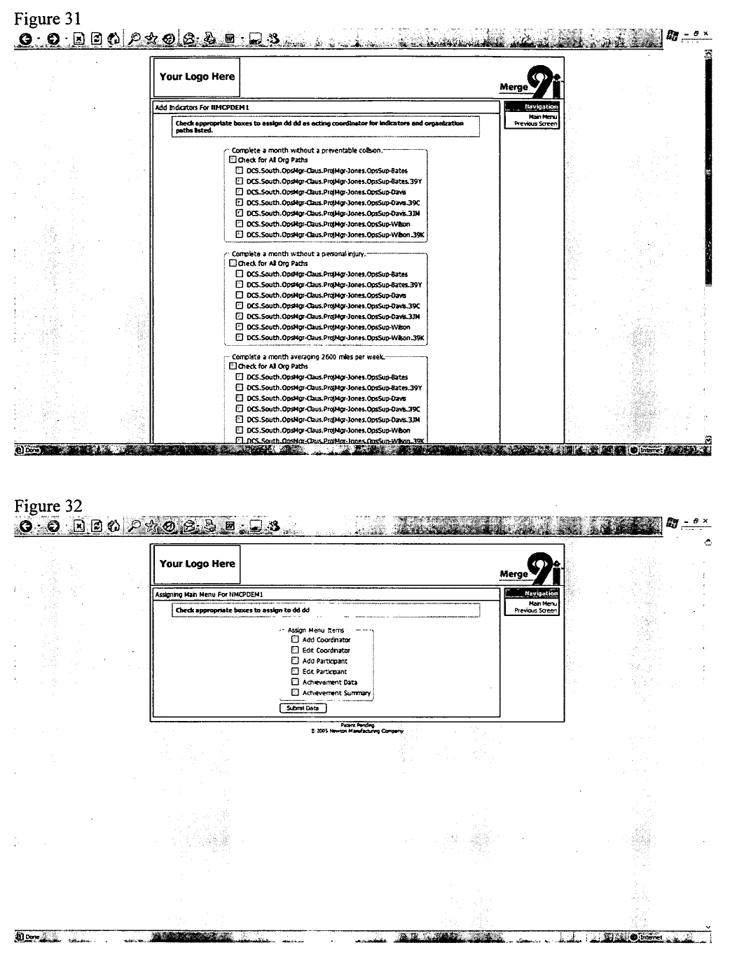

FIG. 29 shows the add coordinator screen. This screen allows for entry of information about coordinators who will have access to the data administration area. After completing the screen shown in FIG. 29, selecting the submit data button displays the screen shown in FIG. 30. FIG. 30 allows for selecting the jobs and organizational paths assigned to the coordinator. Selecting the submit data button shown in FIG. 30 displays the screen shown in FIG. 31. FIG. 31 allows for selecting the indicators and organizational paths assigned to the coordinator. Selecting the submit data button shown in FIG. 31 displays the screen show in FIG. 32. FIG. 32 allows for selecting the data administration functions assigned to the coordinator. Selecting the submit data button finalizes the data entry process for adding a coordinator.

The edit coordinator button shown in FIG. 28 allows for editing the series of screens shown in FIGS. 29-32. This function is performed by first selecting a particular coordinator from a list of coordinators, and then reviewing the screen with the coordinator's personal information shown (see FIG. 29) for editing. The list of positions and organizational paths can be edited, and the indicators by organizational path, as well as the administrative menus assigned to the coordinator.

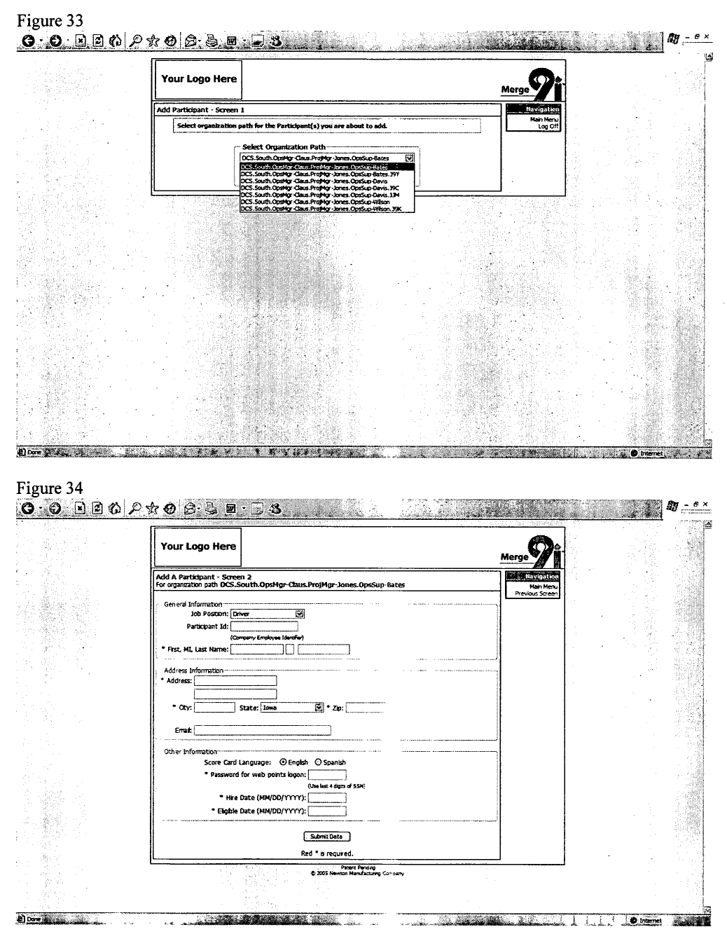

FIG. 33 shows the add participant screen of the data administration area. The screen requires selection of the organizational path that the participant will be associated with. After selecting the organizational path, the screen shown in FIG. 34 is displayed. FIG. 34 allows for adding participant personal information. Selecting the submit data button finalizes the data entry process for adding a participant.

The edit participant button shown in FIG. 28 allows for editing the series of screens shown in FIGS. 33-34.

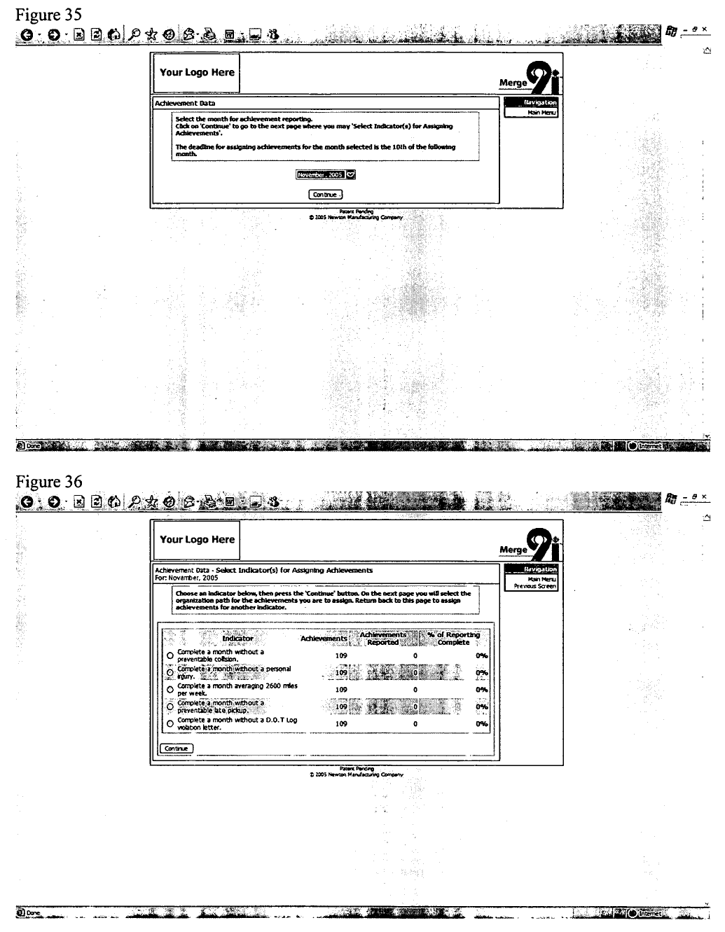

FIG. 35 shows that achievement data screen of the data administration area. The screen requires selecting the indicators that will be available for assignment of points. Due to the fact that all indicators are displayed and tracked by month and year, the month and year must be selected before proceeding. Selecting a month and year from the available choices, and pressing the continue button displays the screen shown in FIG. 36.

FIG. 36 allows for selecting from among the available indicators. Next to each indicator is a number of achievements possible. This is the total number of times this indicator can be achieved. Typically, this indicates the number of members of the organization that can achieve the particular indicator. Also listed is the current number of achievements that have been entered and the percent of member achievements that have been completed for the given task. Pressing the continue button displays the screen shown in FIG. 37.

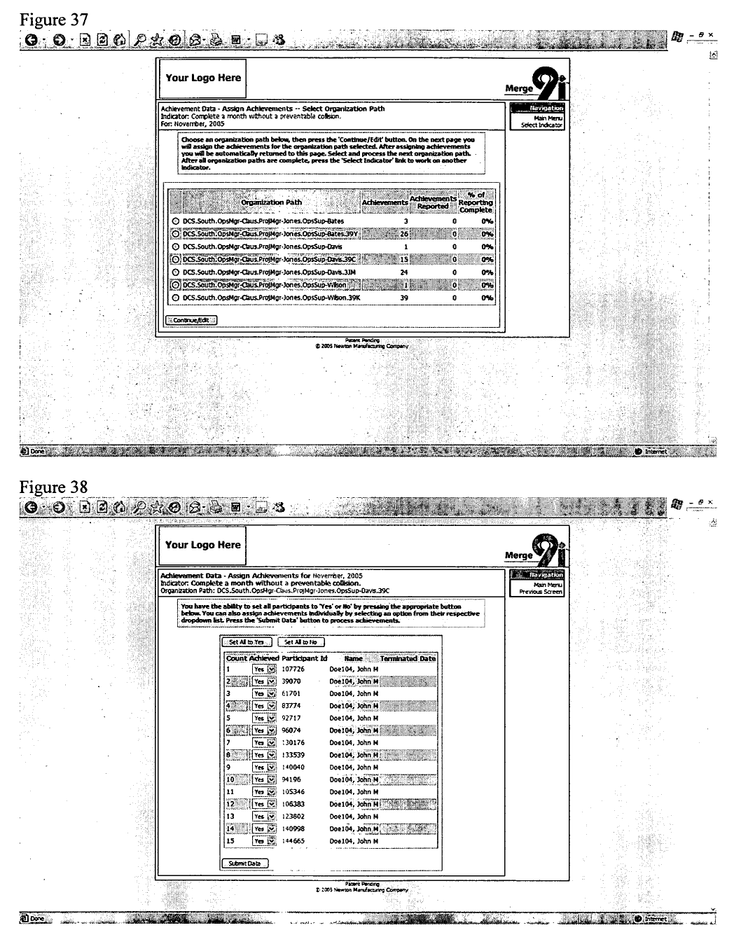

FIG. 37 allows for selecting from among the available organizational paths for the previously selected indicator. The number of achievements is broken out by path, along with the achievements reported and the percent of completed reports for the path/indicator. Pressing the continue/edit button displays the screen shown in FIG. 38.

FIG. 38 shows the members of the organization in the organizational path labeled DCS.South.OpsMgr-Claus.ProjMgr-Jones.OpsSup-Davis.39C in FIG. 37. The path has 15 possible achievements due to the fact that there are 15 members of organization in the particular path. The screen allows for selecting yes, no, or n/a for each member depending on the situation and circumstance for each member of the organizational path with regard to the particular indicator task involved. Default all yes, and all no buttons are available. Pressing the submit data button finalizes the data entry process for achievement data entry. Selecting the yes, no, or n/a field for a member displays a screen that allows for coordinator to change the yes, no, or n/a option for the selected member.

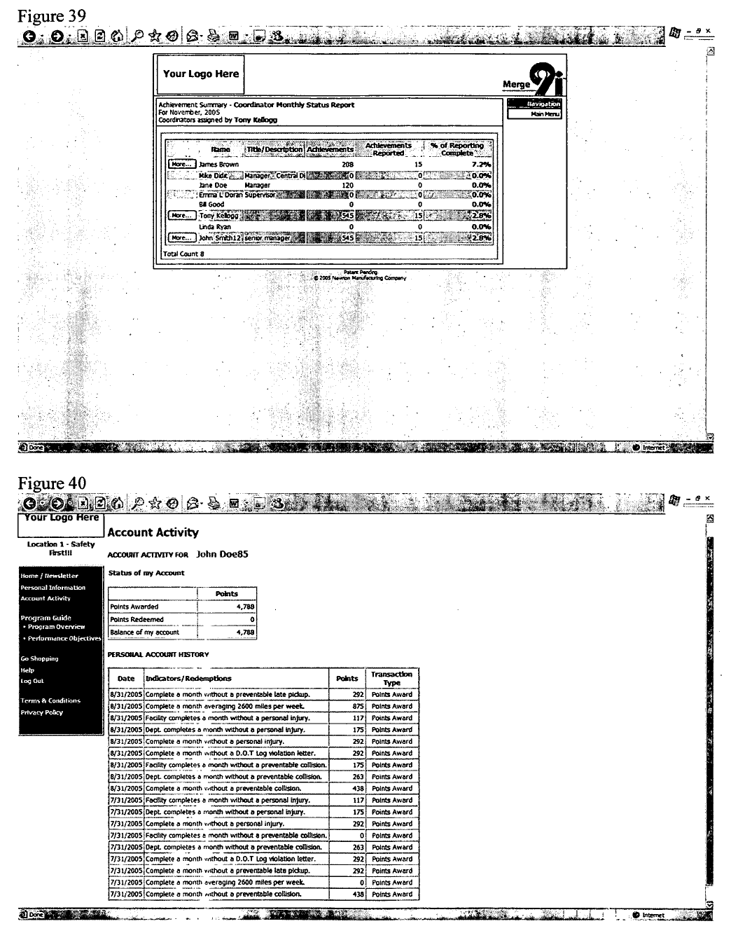

Selecting the achievement summary option show in FIG. 28 displays the screen shown in FIG. 39. FIG. 39 shows entries for all the coordinators including the number of achievements assigned to the coordinator and the report/progress numbers. More information about the coordinator's achievement entries can be viewed by selecting the more information button. The information is displayed on various screens of the type disclosed hereinabove and in the hierarchy of selecting an indicator, selecting a path for the previously selected indicator, and then a list of members and achievement status is displayed.

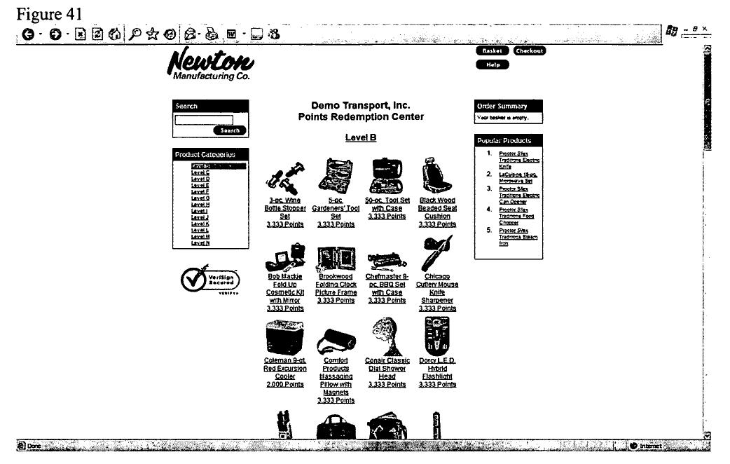

Another aspect of the present invention comprises point redemption. FIGS. 40-41 show the central aspects of the point redemption aspect of the present invention. The point redemption allows the members of the organization to redeem the points they earned in exchange for merchandise or other items. In addition, other general information about the overall award and redemption program is displayed, and information explaining the importance of the particular indicators that the organization has selected for reporting. Also displayed is the overall points that can be assigned for each task/activity, and the breakdown of points by level (individual, board, and account). Of course, the distribution of these points and the tasks for which points will be awarded is arbitrary and will vary from organization to organization.

FIG. 40 displays a summary of a members points awarded and redeemed, along with a break down of the indicators that make up the points awarded. FIG. 41 shows a listing of merchandise that can be redeemed by the member. The redemption basically follows the process of a conventional Internet shopping cart type application, where items are selected and then shipped to the member. The points spent are then transferred from earned to redeemed status.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A hierarchical method of awarding points for meeting performance objectives and providing redemption thereof, said method comprising:
providing a general-purpose computer capable of executing computer instruction code;
providing a software application comprising said computer instruction code capable of carrying out the following steps:
assigning indicators of performance to tasks performed by members of a hierarchical organization;
assigning performance points to said indicators;
awarding some or all of said points to said members based on performance of said tasks;
allowing redemption of some or all of said awarded points; and
displaying said points information hierarchically.
